(19) United States
(12) Patent Application Publication
(10) Pub. No.: US 2008/0071573 A1
(43) Pub. Date: Mar. 20, 2008

(54) Systems and Methods For Providing Real-Time Personalized Psychological Assistance and Stress Management

(76) Inventors: Bonnie E. Owens, Freeport, NY (US); Anita Accardi, Freeport, NY (US); Richard M. Lawless, Watermill, NY (US); Nancy Beckett-Lawless, Watermill, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/841,692

(22) Filed: Aug. 20, 2007

Related U.S. Application Data
(60) Provisional application No. 60/838,939, filed on Aug. 18, 2006.

(51) Int. Cl. G06Q 50/00; G06F 17/30

(52) U.S. Cl. 705/2

(57) ABSTRACT

Systems and methods are disclosed that provide real-time, on-demand personalized psychological first aid and assistance to persons enduring a traumatic event. In one aspect, a personalized psychological Disaster Preparedness Tool (DPT) provides real-time and on demand access to disaster preparedness strategies and trauma response methodologies to provide support and assistance to an individual in coping with, negotiating and navigating the dramatic effects of disaster and trauma.

### CROSS-REFERENCE TO RELATED APPLICATION

This application claims priority to a U.S. Provisional Application Ser. No. 60/838,939 filed on 18 Aug. 2006, which is incorporated herein by reference.

### TECHNICAL FIELD

The present invention relates generally to systems and methods to provide real-time, on-demand personalized psychological first aid and assistance to persons enduring, or who have endured, a traumatic event. More specifically, the present invention relates to a personalized psychological Disaster Preparedness Tool (DPT) that provides real-time and on demand access to disaster preparedness strategies and trauma response methodologies to provide support and assistance to an individual in coping with, negotiating and navigating the dramatic effects of disaster and trauma.

### BACKGROUND

According to the Diagnostical Statistical Manual DSM-IV, psychological trauma is generally considered as an event and or repeated exposure to events that can potentially cause threat to life or physical integrity, emphasizing the subjective characteristics of fear, hopelessness or horror.

Potentially traumatic events, according to DSM-IV include, for example, violent personal assault, being kidnapped, natural or man made disasters, acts of war, acts of terrorism, torture, military combat, severe automobile accidents, being diagnosed with a life-threatening illness, and the death of close family member or friend. During and in the days after a disaster and/or traumatic event, an individual can experience acute stress reactions, while others may develop more severe psychological disorders including but not limited to post traumatic stress disorder.

It is well known that acute stress reactions can affect an individual on various levels—emotionally, behaviorally, physically and/or cognitively, which in turn impairs their ability to function during a traumatic event as well as days or weeks or more following the traumatic event. The emotional reactions can include, for example, sadness/tearfulness, irritability, anger, feelings of anxiety, fear, despair, hopelessness, guilt, shame and emotional disconnection. The behavioral reactions can include, for example, excessive use of drugs, alcohol, prescription drugs or other numbing behaviors such as isolation, withdrawal, hyper vigilance, and exaggerated startle responses, etc. Physical reactions can include, for example, headaches, stomach problems, difficulty falling or staying asleep, difficulty eating, fatigue, chronic exhaustion, etc. Cognitive reactions may include, for example, distressing dreams, intrusive thoughts or images, difficulty making decisions, suicidal thoughts or feelings, inability to accept/cope with death of loved one(s), etc.

There are various conventional trauma response strategies that may be used for treating an individual and help reduce the possibility or prevent an individual from suffering from acute stress reactions or other psychological disorders. These conventional trauma response strategies include, for example, Critical Incident Stress debriefing (CISD), Critical Incident Stress Management (CISM) traditional talk therapy, and cognitive behavioral therapies (CBT).

Although these conventional trauma response strategies are beneficial to some extent, we have found through our experiences with counseling that such techniques are lacking in full therapeutic efficacy, especially for extremely horrible and tragic traumatic events, such as the terrorist attacks in the United States on Sep. 11, 2001.

### SUMMARY OF THE INVENTION

In general, exemplary embodiments of the invention include systems and methods to provide real-time, on-demand personalized psychological first aid and assistance to persons enduring, or who have endured, a traumatic event. In particular, exemplary embodiments of the invention include personalized psychological disaster preparedness tools (DPT) that provide real-time and on demand access to disaster preparedness strategies and trauma response methodologies to provide support and assistance to an individual in coping with, negotiating and navigating the dramatic effects of disaster and trauma.

In accordance with exemplary embodiments of the invention, a personalized psychological DPT is an application that is designed to organize and present different combinations/types of prestored audio and/or visual content or other stimuli or modalities to an individual, which are designed to have different types/levels of therapy effects on the individual and provide various forms of psychological inoculation aimed at mitigating and or diffusing the severity of immediate acute trauma stress reactions, and reducing the potential for the manifestation of post traumatic stress disorder, and other psychologically impairing conditions.

A personalized psychological disaster preparedness tool can be designed to provide psychological assistance for various types/categories of traumatic events (e.g., natural disasters, acts of terrorism, pandemic events, life threatening illnesses, chronic health problems, death of loved one, etc.). Each type/category of traumatic event may have the same, similar or different types/classifications of “tracks” depending on the type of trauma response strategies that are best indicated for the individual user's symptoms and job capacity. A personalized psychological disaster preparedness tool can have different tracks that are designed to provide immediate self-help trauma response strategies and/or psychological first aid to an individual.

In one exemplary embodiment, a personalized psychological DPT can be a application that executes on a portable computing device that is uniquely packaged and designed for the given application, or other types of portable hand held computing devices, such as cell phones, brand name MP3 players (e.g. IPOD), PDA's (personal digital assistant), that are formatted and developed with the necessary software and hardware to provide an individual real-time, on demand access to a plurality of resources intended to help the individual cope with a disaster or an otherwise traumatic event at the time of such event and thereafter. The DPT device can also be specifically designed for large screen projection for purposes of addressing mass audiences, and training workshops for the identified specialized target markets.

These and other exemplary embodiments, aspects, features and advantages of the present invention will become apparent from the following detailed description of exemplary embodiments that is to be read in connection with the accompanying drawings.

### BRIEF DESCRIPTION OF THE DRAWINGS

FIG. 1 schematically illustrates a general framework of a portable computing device that may be used to implement a personal psychological disaster preparedness tool according to an exemplary embodiment of the invention.

FIG. 2 is a block diagram of a personal psychological disaster preparedness tool, according to an exemplary embodiment of the invention.

### DETAILED DESCRIPTION OF EXEMPLARY EMBODIMENTS

A personal psychological disaster preparedness tool (DPT) according to an exemplary embodiment of the invention differs from conventional trauma response strategies (such as Critical Incident Stress Debriefing) in very significant ways—a DPT is not a pamphlet, booklet or structured group session but rather a real time individual experience of sound, information and emotional comfort, impacting an individual in a very deep way when the individual is in need the strength and support either during or after suffering a traumatic event or disaster. The content and concepts translate across a range of spoken languages and cultures, and thus will be provided in a variety of languages and with an emphasis on cultural sensitivity. A DPT according to an exemplary embodiment of the invention can be designed to meet specific needs of a variety of users, tailoring tracks to meet the needs of the general public, as well as the specialized needs of such groups as emergency first responders, the military, clinicians, medical personnel, etc, addressing their specific operational responsibilities and job sensitivities. A unique feature of an exemplary DPT is its portability and the immediate access to coping strategies it affords, as well as its multidimensional learning modalities and real time-on demand sound, text and visual content for psychological first aid and trauma response. As a resource for people in the aftermath of any traumatic event, the Disaster Preparedness Toolkit holds a real promise of psychologically inoculating people from Acute Stress reactions and/or developing more severe forms of psychological disorders, including but not limited to Post Traumatic Stress Disorder.

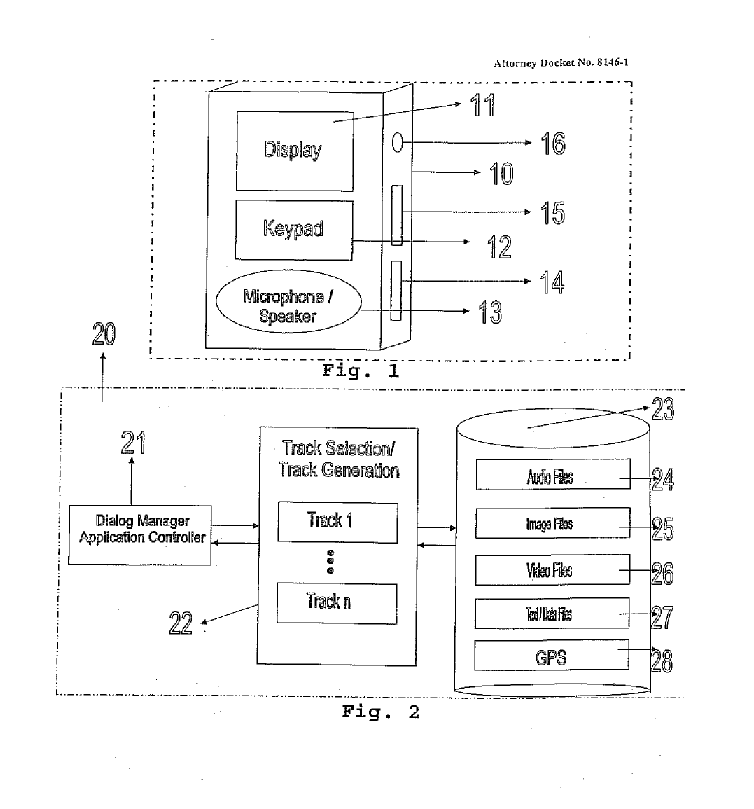

FIG. 1 is a high-level schematic illustration of a computing device (10) which can be used as a platform for executing or otherwise interacting with a DPT application (20) such as depicted in FIG. 2. In particular, FIG. 1 illustrates an exemplary embodiment of an MP3 player uniquely designed, and packaged, as well as other portable, hand-held computing devices (10) having a display screen (11), keypad (12) and microphone and/or speaker (13), earplug (14), ac adapter outlet (15), projection device portal (16). The DPT device (10) may be a portable device specifically designed for the given application, or another type of portable device such as a cell phone, IPOD or other type of PDA (personal digital assistant) device having the necessary hardware/software to implement a personal psychological disaster toolkit as described herein. It is to be understood that the exemplary DPT device (10) is depicted as having GUI (graphic user interface) and audio I/O modalities, although the present invention may be implemented in audio-only or visual-only user interface modality, depending on the user-interface capabilities of the portable device (10).

It is to be understood that the term “computing device” is intended to broadly refer to any member of a class of devices employing embedded computing systems to provide all or part of their functionality. Depending on the application, the computing device (10) may have additional user interface I/O components disposed on the device housing which may be used to implement and control operation of the a DPT (20) as depicted in FIG. 2. The computing device (10) may comprise embedded processors, CPUs, and control circuits as well as one or more different types of embedded memory (e.g., ROM and/or programmable ROM such as FLASH ROM memory) for storing program code/software such as an operating system to operate the computing device (10) and software applications/tools, such as a DPT (20), that are hosted by the computing device 120).

FIG. 2 is a high-level system diagram of a personal DPT application (20), according to an exemplary embodiment of the invention. The application tool (20) generally comprises a dialog manager and application controller module (21), a track selection and track generation module (22) and a database manager system (23) for managing various types of resources such as audio files (24), image files (25), video files (26) and textual/data files (27), global position system (GPS) files (28). In general, the dialog manager and application controller (21) is a system module that supports user interaction with the application tool (20), processes user queries/commands, and controls execution flow of the application functions, which can vary depending on the application. The application tool (20) is designed to provide various functionalities and informational resources to provide a wide range of on-demand real-time disaster preparedness strategies and trauma response methodologies and techniques to assist the user in coping and negotiating the physical and psychological effects of the event.

In accordance with an exemplary embodiment of the invention, various disaster preparedness strategies and trauma response methodologies and techniques are classified according to different “tracks” (e.g., track 1˜track n) for a given type of traumatic event. For example, in one exemplary embodiment, a set of “Tracks” may be classified/defined as follows:

Track One: Introduction: “Hold On!”—this track is designed to inform the person that their current feelings, actions, etc. are normal given the event, and that their first helpful action would be to lessen their agitation. The types of files/data for this track would include, for example, some brief, calming visualizations (proprietary or user personalized) to put the person at ease. Moreover, a personal adversities life-line may be suggested as a reminder of past success in coping with difficult situations.

Track Two: “What to Do Right Now”—First Aid/Preventive Actions—for a given event, this track may offer advice as to the various types of first aid and maintenance procedures that the person may readily perform, summarized in the catch phrase, “Pee it out, sweat it out, talk it out,” meaning lots of water, some kind of physical movement, and definitely conversation with others. Moreover, scripted conversations can be played backed (via audio files, or text sentences output in audio via TTS (text to speech synthesis) to ease the burden. Also, kindness and reaching out to others as a coping tool will be encouraged. Finally, depending on the event, some inspiring words can be given about the strength and power of the human spirit, given by the authors and some first responders from Sep. 11, 2001.

Track Three: Trauma Therapy—to help desensitize a person to the trauma and reduce mental and psychological stress resulting from traumatic event. This may be achieved using certain visualizations and guided imagery that have a positive cognitive response for the given individual. Moreover, the track may provide user guidance to perform brief yet powerful breathing exercises as psychological first aid in coping with a traumatic experience, or other relaxation techniques. This track may finish with PRAYERS FROM MANY TRADITIONS to help ease stress and anxiety.

Track Four: MUSIC Therapy—certain music such as hymns, songs, psalms, spirituals, anthems, etc. may be played back to the user. The music may be pre-recorded files or audio files accessed in real-time from a remote data source.

Track Five: Family and Children Track—This track may be designed to present various type of activities and suggestions on how to talk to children who have witnessed or otherwise experienced a traumatic event (e.g., death of parent or favorite pet). This track may present a special guided meditation for families on courage (by Belleruth Naparstek), children's' songs, lullabies, short stories, fairy tales, kids jokes, children's games, etc. For older children (teenagers), the track may present means for writing a journal, performing creative writing, performing art projects. This track may allow presentation of favorite family photographs.

Track Six: INSPIRATION. This track can be designed to present certain sound bite quotes from famous inspirational people such as Nelson Mandela, Malcolm X, Mother Theresa, Rosa Parks, etc. Moreover, this track may permit the recording of a person's favorite inspiring poems, quotations, etc.

Track Seven: AFFIRMATIONS: This track may be designed to present inspiring, calming, energizing positive statements as research shows repetition of such material has a major positive impact on trauma survivors. Also, this track may offer user guidance for practicing Positive Self-Talk.

Track Eight: Personal and Family Data track. This track may be designed to present pre and post downloadable sections for post disaster (or traumatic event) recovery. Other relevant resources may be presented to allow a person to cope with the aftermath of a disaster.

Track Nine: The Stories of Survivors track. This track may be designed to present stories by survivors of other disasters or traumatic events to further inspire the listener and encourage him/her not to give up.

Track Ten: The Journaling and Personal Story track. There may also be a recordable section for the user's own journal of his/her experience and story, both of the event and the time afterwards; the listener will be encouraged to tell their story for both therapeutic usefulness and to give others the gift of their unique experience.

Track Eleven: The Before the Disaster Happens: Things to Do Ahead of Time track. This recordable section may be designed to afford the user a comprehensive list of important data such as contact information for key people; insurance policy numbers; instructions for survivors on retrieving wills, proxies and requests for funeral arrangements; and whatever other information is deemed critical. Further, the track may include standard lists of things to do that would ready an individual or family or other group for a disaster.

Track Twelve: Simple Screening Tools for Self Assessment. This track may be designed as a collection of easily understood, common self-screening tools for acute trauma, post traumatic stress disorder, depression, etc. It is felt that it may empower a listener to test him or herself and encourage professional help when that became available.

Track Thirteen: Basic First Aid. This track may be designed with audio and visual guides to basic first aid techniques including bandaging, CPR, hydration, etc.

Each “track” is designed to provide different types and levels of psychological first aid and suggestions, for coping and handling pre and post traumatic events. Depending on the user selected “track”, the track generation module (22) can retrieve the relevant files/data (24-27) for playback/presentation to the user. In other words, with this framework, different “tracks” are designed to have different therapeutic effects, all aimed in reducing the users Acute Stress Responses. Different types of images, video clips, audio clips (words, songs), etc., alone or in combination are selected and presented for different types of “tracks” depending on the occupation, functionality and coping needs of the user.

When interacting with the application tool (20), the user may first select (from a menu option) the relevant traumatic event type (assuming the tool (20) supports such events). The track selection/generation module (22) may be configured to automatically present one or more tracks (e.g., an introductory track), and allow the user to select one or more desired “tracks” depending on the user's needs. In other exemplary embodiments, the application tool (20) may be designed to automatically select a given “track” for presentation to the user based on a prediction of the user's needs (as determined from user responses to system queries, etc.).

It is to be understood that the system modules and methods described herein may be implemented in various forms of hardware, software, firmware, special purpose processors, or a combination thereof. For example, the DPT application (20) of FIG. 2 may be implemented in software as an application comprising program instructions that are tangibly embodied on one or more program storage devices (e.g., hard disk, magnetic floppy disk, RAM, CD ROM, ROM and Flash memory) and executable by any device or machine comprising suitable architecture. It is to be further understood that since the constituent system modules (20) and method steps may be implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

Moreover, the entire application tool (20) may be a stand alone application that fully resides and executes in the DPT device (10) of FIG. 1, for example. In such instance, the DPT device (10) includes suitable resources (processing power and memory) to execute the application and store the desired files/data (24-27). In another embodiment, the database (23) of files/data (24-27) may reside at a remote network node and that is accessible by the DPT device (10) via a network connection.

In other exemplary embodiments of the invention, the application tool (20) may be a web application which resides on a remote network node and which is remotely accessible using the DPT device (10). In such embodiment, the application tool (20) may be a web service in which a plurality of users can register and enroll and remotely access. The remote repository (23) of files/data files (24-27) may comprises predefined set of resources (as provided by the author of the application tool (20) or by the service provider), as well as personalized resources that are provided by authorized users of the web application tool. In this regard, each user may have a separate, private database of personalized files/data that is managed by the web service, which can be used in conjunction with publicly accessible file/data resources to generate and present “tracks” to the authorized user for a given event.

Moreover, one or more users may authorize use of certain of their personalized files/data for presenting “tracks” to other authorized users of the web application tool. In this regard, the database (23) of informational resources can be dynamically modified and adapted on a continuing basis, using machine learning techniques to continually adapt optimize the type of information provided in certain “tracks” or otherwise define new track-types for different events.

It is to be appreciated that the exemplary systems and methods described herein may be implemented in various markets for use by individual consumers, FEMA personnel and other federal agencies tasked with emergency preparedness, local and state emergency management agencies, first responders including police, fire and EMS agencies, the armed services, major corporations, health care facilities, educational institutions and school districts, Hotel Chains, Cruise Lines, Cultural and Sport Complexes, American Red Cross, etc. In all instance, the personal psychological disaster preparedness toolkit will be designed with various functions and resources to help people cope and navigate the physiological, cognitive, and psychological affects of a disaster in real time, as well as the days thereafter the event(s). Moreover to mitigate, and/or diffuse, the suffering of great shock and trauma so as to reduce or eliminate the possibility of further and more severe and impairing psychological damage.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A system to provide real-time, on-demand psychological first aid and assistance to an individual, the system comprising:
a repository for storing audio, visual, video content and textual content; and
a computing device that comprises a psychological disaster preparedness application tool which organizes and presents the visual, audio content and textual content stored in the repository into a plurality of different tracks, wherein the different tracks are designed to include varying combinations of the pre-stored audio, visual and textual content to present various disaster preparedness strategies and trauma response methodologies and techniques to a user to provide real-time, on-demand psychological first aid and assistance to the individual for one or more types of traumatic events.

2. The system of claim 1, wherein the repository is a storage device that is contained in the computing device.

3. The system of claim 1, wherein the plurality of different tracks include a one or more tracks that provide instructions or guidance for first aid or preventative actions with regard to a given traumatic event.

4. The system of claim 1, wherein the plurality of different tracks include one or more tracks that are designed to present various types of activities or suggestions on how to provide psychological assistance to another person suffering a traumatic event.

5. The system of claim 1, wherein the plurality of different tracks include one or more tracks that presents informative information on what actions an individual should take before and after a traumatic event to prepare for or otherwise cope with a given traumatic event.

6. The system of claim 1, wherein the plurality of different tracks include different tracks that provide varying levels of psychological therapeutic assistance to an individual suffering a traumatic event.

7. The system of claim 1, wherein the plurality of different tracks include one or more tracks that include stories of other individuals that have suffering a similar traumatic event.

8. The system of claim 1, wherein the plurality of different tracks include one or more tracks that provide instructions for administering first aid for a given traumatic event.

9. The system of claim 1, wherein the plurality of different tracks includes different sets of tracks that are each associated with one of a plurality of different types of traumatic events or disasters.

10. The system of claim 1, wherein the computing device is a handheld portable computing device.

11. The system of claim 1, wherein the audio, visual, video content and textual content are pres-selected to provide therapeutic effects over a broad class of individuals.

12. The system of claim 1, wherein the audio, visual, video content and textual content is personalized for a given individual.

13. A method for providing real-time, on-demand psychological first aid and assistance to an individual, comprising:
storing audio, visual, video content and textual content in a repository;
classifying the visual, audio content and textual content stored in the repository into a plurality of different tracks, wherein the different tracks are designed to include varying combinations of the pre-stored audio, visual and textual content that provide various disaster preparedness strategies and trauma response methodologies and techniques to a user; and
presenting one or more different tracks to an individual to provide real-time, on-demand psychological first aid and assistance to the individual for one or more types of traumatic events.

14. The method of claim 13, wherein classifying the visual, audio content and textual content stored in the repository into a plurality of different tracks comprises organizing the content into sets of tracks that support different types of traumatic events or disasters.

15. The method of claim 13, wherein presenting one or more different tracks to an individual comprises presenting a track of the stored content which provides instructions or guidance for first aid or preventative actions with regard to a given traumatic event.

16. The method of claim 13, wherein presenting one or more different tracks to an individual comprises presenting a track of the stored content which provides various types of activities or suggestions on how to provide psychological assistance to another person suffering a traumatic event.

17. The method of claim 13, wherein presenting one or more different tracks to an individual comprises presenting a track of the stored content which includes stories of other individuals that have suffering a similar traumatic event.

18. The method of claim 13, wherein presenting one or more different tracks to an individual comprises presenting a track of the stored content which provides instructions for administering first aid for a given traumatic event.

19. The method of claim 13, wherein presenting one or more different tracks to an individual comprises presenting one or more tracks of the stored content which are designed to provide differ therapeutic effects to the individual.

20. A program storage device readable by machine, tangibly embodying a program of instructions executable by the machine to perform method steps for providing real-time, on-demand psychological first aid and assistance to an individual, the method steps comprising:
storing audio, visual, video content and textual content in a repository;
classifying the visual, audio content and textual content stored in the repository into a plurality of different tracks, wherein the different tracks are designed to include varying combinations of the pre-stored audio, visual and textual content that provide various disaster preparedness strategies and trauma response methodologies and techniques to a user; and
presenting one or more different tracks to an individual to provide real-time, on-demand psychological first aid and assistance to the individual for one or more types of traumatic events.
